(19) United States
(12) Patent Application Publication
(10) Pub. No.: US 2024/0414704 A1
(43) Pub. Date: Dec. 12, 2024

(54) TERMINAL, BASE STATION AND COMMUNICATION METHOD

(71) Applicant: NTT DOCOMO, INC., Tokyo (JP)

(72) Inventors: Yuki Takahashi, Chiyoda-ku, Tokyo (JP); Satoshi Nagata, Chiyoda-ku, Tokyo (JP); Qiping Pi, Haidian District, Beijing (CN); Jing Wang, Haidian District, Beijing (CN); Lan Chen, Haidian District, Beijing (CN)

(73) Assignee: NTT DOCOMO, INC., Tokyo (JP)

(21) Appl. No.: 18/700,155

(22) PCT Filed: Oct. 11, 2022
(86) PCT No.: PCT/JP2022/037902

§ 371 Date: Apr. 10, 2024

(30) Foreign Application Priority Data
Oct. 18, 2021 (JP) 2021-170070

(51) Int. Cl. H04W 72/11; H04W 72/1263

(52) U.S. Cl. CPC H04W 72/11; H04W 72/1263

(57) ABSTRACT

A terminal includes: a reception unit configured to receive downlink control information activating semi-persistent scheduling and downlink data according to the activated semi-persistent scheduling from a base station; a control unit configured to determine a cell for feedback for the downlink data in a case where dynamic carrier switching is enabled; and a transmission unit configured to use the determined cell to transmit feedback information corresponding to the downlink data to the base station.

### FIELD OF THE INVENTION

The present invention relates to a terminal, a base station and a communication method in a wireless communication system.

### BACKGROUND OF THE INVENTION

Regarding NR (New Radio) (also referred to as “5G”), or a successor system to LTE (Long Term Evolution), technologies have been discussed which satisfy the following requirements: a high capacity system, high data transmission rate, low delay, simultaneous connection of multiple terminals, low cost, power saving, etc. (for example, Non-Patent Document 1).

In addition, in NR, discussions about the semi-persistent scheduling (SPS) for reducing the downlink overhead are continued from LTE. Furthermore, in NR, PUCCH (Physical Uplink Control Channel) carrier switching is being discussed for the extension of URLLC (Ultra-Reliable and Low Latency Communications) technology. The PUCCH carrier switching has been discussed as a method of reducing the latency of HARQ-ACK (Hybrid Automatic Repeat reQuest-ACKnowledgement) feedback in the TDD (Time Division Duplex) scheme.

In a case where dynamic carrier switching for dynamically executing PUCCH carrier switching based on an indication by downlink control information (DCI) is enabled, discussions are being held on an idea of applying an indication of a PUCCH cell for feedback (HARQ-ACK) corresponding to a downlink shared data channel (SPS-PDSCH) scheduled by semi-persistent scheduling (SPS) without downlink control information (DCI), to the first downlink shared data channel (SPS-PDSCH) activated by downlink control information (DCI).

### CITATION LIST

### Non-Patent Document

Non-Patent Document 1: 3GPP TS 38.300 V16.6.0 (2021-06)

### SUMMARY OF THE INVENTION

### Technical Problem

In a case where dynamic carrier switching is enabled, there is a problem that there is no specification on how to specify the PUCCH cell for feedback (HARQ-ACK) corresponding to subsequent downlink shared data channels (SPS-PDSCH) scheduled without downlink control information (DCI).

The present invention has been made in view of the above, and an object of the present invention is to provide a technique that enables to specify a cell for feedback for downlink data according to semi-persistent scheduling in a case where dynamic carrier switching is enabled.

### Solution to Problem

According to the disclosed technique, a terminal is provided. The terminal includes: a reception unit configured to receive downlink control information activating semi-persistent scheduling and downlink data according to the activated semi-persistent scheduling from a base station; a control unit configured to determine a cell for feedback for the downlink data in a case where dynamic carrier switching is enabled; and a transmission unit configured to use the determined cell to transmit feedback information corresponding to the downlink data to the base station.

### Advantageous Effects of Invention

According to the disclosed technique, a technique is provided that enables to specify a cell for feedback for downlink data according to semi-persistent scheduling in a case where dynamic carrier switching is enabled.

### BRIEF DESCRIPTION OF THE DRAWINGS

FIG. 1 is a first drawing illustrating a wireless communication system according to an embodiment of the present invention.

FIG. 2 is a second drawing illustrating a wireless communication system according to an embodiment of the present invention.

FIG. 3 is a drawing illustrating an example of a basic procedure according to an embodiment of the present invention.

FIG. 4 is a sequence diagram illustrating an example of an SPS processing flow in an embodiment of the present invention.

FIG. 5 is a drawing illustrating a method of determining the HARQ-ACK cell related to Option 1 in Embodiment 1.

FIG. 6 is a drawing illustrating a method of determination the HARQ-ACK cell related to Option 2 in Embodiment 1.

FIG. 7 is a drawing illustrating a method of determining the HARQ-ACK cell related to Case 3 in Embodiment 2.

FIG. 8 is a drawing illustrating a method of determining the HARQ-ACK cell related to Case 4 in Embodiment 2.

FIG. 9 is a drawing illustrating an example of a functional structure of a base station 10 according to an embodiment of the present invention.

FIG. 10 is a drawing illustrating an example of a functional structure of a terminal 20 according to an embodiment of the present invention.

FIG. 11 is a drawing illustrating an example of a hardware structure of a base station 10 or a terminal 20 according to an embodiment of the present invention.

FIG. 12 is a drawing illustrating an example of a structure of a vehicle 2001 according to an embodiment of the present invention.

### DETAILED DESCRIPTION OF THE PREFERRED EMBODIMENTS

In the following, referring to the drawings, one or more embodiments of the present invention will be described. It should be noted that the embodiments described below are examples. Embodiments of the present invention are not limited to the following embodiments.

In operations of a wireless communication system according to an embodiment of the present invention, conventional techniques will be used accordingly. The conventional techniques include, but are not limited to, conventional NR or LTE, for example. Further, it is assumed that the term “LTE” used in the present specification has, unless otherwise specifically mentioned, a broad meaning including a scheme of LTE-Advanced and a scheme after LTE-Advanced (e.g., NR).

Furthermore, in one or more embodiments described below, terms that are used in the existing LTE are used, such as SS (Synchronization signal), PSS (Primary SS), SSS (Secondary SS), PBCH (Physical broadcast channel), PRACH (Physical random access channel), PDCCH (Physical Downlink Control Channel), PDSCH (Physical Downlink Shared Channel), PUCCH (Physical Uplink Control Channel), PUSCH (Physical Uplink Shared Channel), etc. The above-described terms are used for the sake of description convenience. Signals, functions, etc., which are similar to the above-described terms, may be referred to as different names. Further, terms, which are used in NR and correspond to the above-described terms, are NR-SS, NR-PSS, NR-SSS, NR-PBCH, NR-PRACH, etc. However, even when a signal is used for NR, there may be a case in which the signal is not referred to as “NR-”.

Furthermore, in an embodiment of the present invention, the duplex scheme may be TDD (Time Division Duplex) scheme, FDD (Frequency Division Duplex) scheme, or other schemes (e.g., Flexible Duplex, or the like).

Further, in an embodiment of the present invention, the expression, a radio parameter is “configured” may mean that a predetermined value is pre-configured, or may mean that a radio parameter indicated by the base station or the terminal is configured.

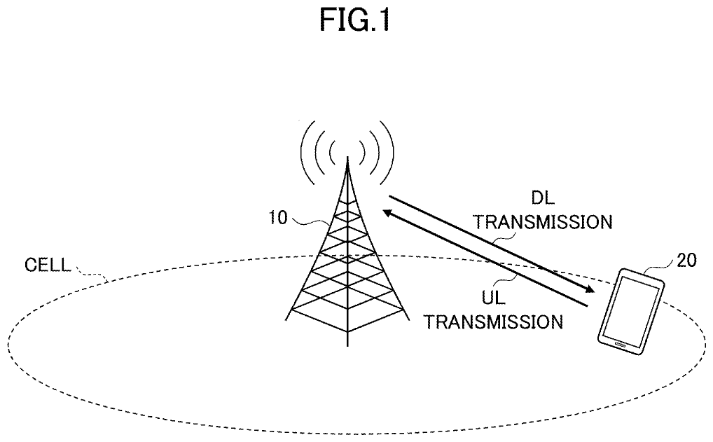

FIG. 1 is a first drawing illustrating a wireless communication system according to an embodiment of the present invention. As illustrated in FIG. 1, a wireless communication system according to an embodiment of the present invention includes a base station 10 and a terminal 20. In FIG. 1, a single base station 10 and a single terminal 20 are illustrated as an example. There may be a plurality of base stations 10 and a plurality of terminals 20.

The base station 10 is a communication apparatus that provides one or more cells and performs wireless communications with the terminal 20. Physical resources of the radio signal may be defined in the time domain and the frequency domain, the time domain may be defined by the number of OFDM symbols, and the frequency domain may be defined by the number of sub-carriers or resource blocks. Further, a TTI (Transmission Time Interval) in the time domain may be a slot, or the TTI may be a subframe.

The base station 10 can perform carrier aggregation to communicate with the terminal 20 by bundling a plurality of cells (multiple CCs (component carriers)). One PCell (primary cell) and one or more SCells (secondary cells) are used in the carrier aggregation.

The base station 10 transmits a synchronization signal, system information, and the like, to the terminal 20. The synchronization signal is, for example, an NR-PSS and an NR-SSS. The system information may be transmitted via a NR-PBCH or a PDSCH, for example, and may be referred to as broadcast information. As shown in FIG. 1, the base station 10 transmits a control signal or data in DL (Downlink) to the terminal 20 and receives a control signal or data in UL (Uplink) from the terminal 20. Note that, here, what is transmitted via a control channel such as PUCCH and PDCCH is called a control signal, and what is transmitted via a shared channel such as PUSCH and PDSCH is called data. These names are mere examples.

The terminal 20 may be a communication apparatus that includes a wireless communication function such as a smart-phone, a mobile phone, a tablet, a wearable terminal, a communication module for M2M (Machine-to-Machine), or the like. As shown in FIG. 1, the terminal 20 uses various communication services provided by the wireless communication system by receiving control signals or data in DL from the base station 10 and transmitting control signals or data in UL to the base station 10. Note that the terminal 20 may be referred to as a UE, and the base station 10 may be referred to as a gNB.

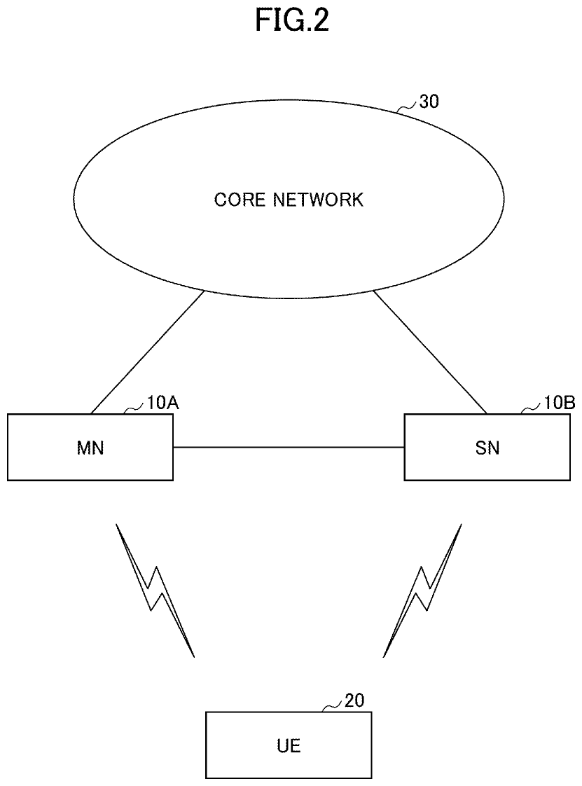

FIG. 2 is a second drawing illustrating a wireless communication system according to an embodiment of the present invention. FIG. 2 illustrates an example of a configuration of a wireless communication system in a case where dual connectivity (DC) is performed. As shown in FIG. 2, a base station 10A serving as a Master Node (MN) and a base station 10B serving as a Secondary Node (SN) are provided. The base station 10A and the base station 10B are each connected to a core network 30. The terminal 20 is enabled to communicate with both the base station 10A and the base station 10B.

A cell group provided by the base station 10A serving as an MN is called a Master Cell Group (MCG), and a cell group provided by the base station 10B serving as an SN is called a Secondary Cell Group (SCG). In addition, in the dual connectivity, the MCG is composed of one PCell and zero or more SCells, and the SCG is composed of one PSCell (Primary SCG Cell) and zero or more SCells.

The dual connectivity may be a communication method using two communication standards, and any communication standards may be combined. For example, the combination may be NR and 6G standards, or may be LTE and 6G standards. In addition, the dual connectivity may be a communication method using three or more communication standards and may be referred to as another name different from the dual connectivity.

Processing operations in this embodiment may be performed in a system configuration shown in FIG. 1, in a system configuration shown in FIG. 2, or in other system configurations.

In the 3GPP (Registered Trademark) standardization, supporting the enhanced IoT (Internet of Things) and URLLC (Ultra-Reliable and Low Latency Communication) in NR has been discussed. In addition, enhancement of HARQ-ACK (Hybrid Automatic Repeat Request Acknowledgement) is being discussed to address URLLC requirements.

### (Basic Operation)

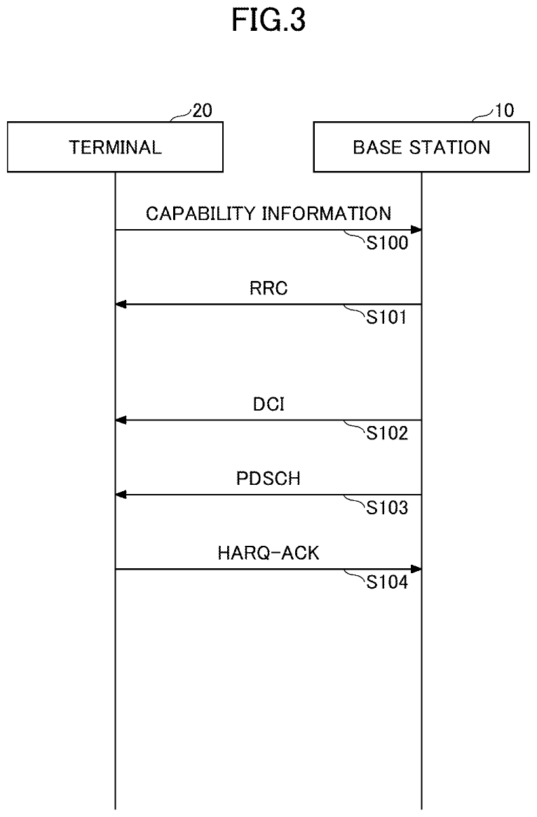

FIG. 3 is a drawing illustrating an example of a basic procedure according to an embodiment of the present invention. First, an example of a basic operation in a wireless communication system according to an embodiment of the present invention will be described with reference to FIG. 3.

In S100, the terminal 20 transmits capability information (UE capability) to the base station 10. The base station 10 can determine, for example, the content of the information to be transmitted to the terminal 20 in the following S101 and S102 based on the capability information.

In S101, the base station 10 transmits configuration information to the terminal 20 via an RRC message, and the terminal 20 receives the configuration information. The configuration information is, for example, configuration information related to a K1 set and a TDRA table as described below. Both the K1 set and the TDRA table may be indicated from the base station 10 to the terminal 20, or may be predetermined by technical specifications or the like, and the base station 10 and the terminal 20 may use the predetermined K1 set and TDRA table. In addition, the TDRA table may be referred to as time domain resource assignment configuration information.

In S102, the base station 10 transmits, to the terminal 20, scheduling (allocation information) for a plurality of PDSCHs via a DCI, and the terminal 20 receives the DCI. In addition, the DCI contains information related to uplink resources for transmitting HARQ-ACK information.

In S103, the terminal 20 receives the PDSCHs based on the scheduling information in the DCI and transmits the HARQ-ACK information to the base station 10 in S104. The base station 10 receives the HARQ-ACK information.

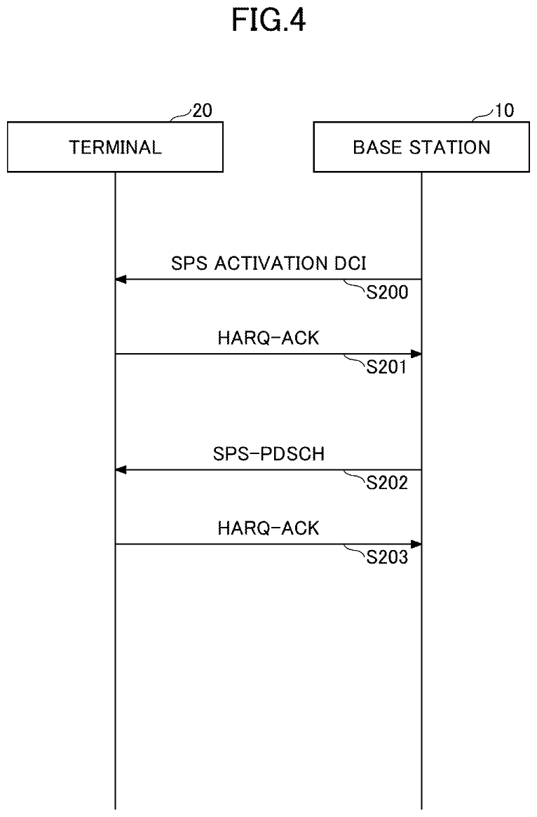

Next, the processing flow of semi-persistent scheduling (SPS) will be described. FIG. 4 is a sequence diagram illustrating an example of an SPS processing flow in an embodiment of the present invention.

When SPS is configured by RRC or the like, the base station 10 indicates, to the terminal 20, the start of SPS by DCI (step S200). The DCI used for indicating the start of SPS is called SPS activation DCI.

Upon receiving the SPS activation DCI, the terminal 20 transmits HARQ-ACK information to the base station 10 as feedback to the SPS activation DCI (step S201).

Next, until the base station 10 indicates the end of the SPS to the terminal 20, when downlink data occurs, the base station 10 transmits the PDSCH containing the downlink data to the terminal 20 without transmitting the DCI (step S202). The PDSCH without DCI is called SPS-PDSCH.

When the start of semi-persistent scheduling is indicated, the terminal 20 assumes that downlink data scheduled based on the pre-configured period will be transmitted from the base station. When SPS-PDSCH is received, the terminal 20 transmits HARQ-ACK information corresponding to the SPS-PDSCH to the base station 10 (step S203). Hereafter, HARQ-ACK for SPS-PDSCH is referred to as SPS-HARQ-ACK.

Here, in a case where dynamic carrier switching is enabled, the HARQ-ACK can be classified into the following three categories.

Category-1 HARQ-ACK is HARQ-ACK for SPS-PDSCH without DCI (SPS-HARQ-ACK). In a case where dynamic carrier switching is enabled, discussions are being held on an idea of applying an indication of a PUCCH cell for the HARQ-ACK for the SPS-PDSCH scheduled by semi-persistent scheduling (SPS) without DCI, to the first SPS-PDSCH activated by DCI.

However, in a case where dynamic carrier switching is enabled, there is a problem that there is no specification on how to specify the PUCCH cell for HARQ-ACK for subsequent SPS-PDSCH without DCI (SPS-HARQ-ACK, that is, category-1 HARQ-ACK).

Here, the PUCCH cell for interpreting the K1 value of the category-1 HARQ-ACK may be any one of the following options. As Option 1, the PUCCH cell may be a default cell, i.e., Pcell, PSCell or PUCCH-Scell. As Option 2, the PUCCH cell may be a PUCCH cell that is indicated by the PUCCH cell indication field of the SPS activation DCI.

The category-2 HARQ-ACK is a HARQ-ACK: for PDSCH scheduled by DCI; for Scell dormancy DCI; or for SPS release DCI, where the DCI includes PUCCH cell indication field.

In NR, it is being discussed that PUCCH slots overlapping with dynamic PUCCH cell indication on multiple cells need not be expected.

The category-3 HARQ-ACK is a HARQ-ACK: for PDSCH scheduled by DCI; for Scell dormancy DCI; or for SPS release DCI, where the DCI does not include PUCCH cell indication field.

In NR, it is being discussed that the PUCCH cell for category-3 HARQ-ACK is a default cell or follows an indication by another DCI. From the standardization perspective, it is mostly possible to be Pcell, PSCell or PUCCH-Scell.

### (Problem of Conventional Technique)

Here, because the SPS-PDSCH is not accompanied by DCI, how to determine the cell for transmitting the HARQ-ACK information becomes a problem. In other words, in a case where dynamic carrier switching is enabled, there is a problem that there is no specification on how to specify the PUCCH cell for HARQ-ACK for subsequent SPS-PDSCH without DCI (SPS-HARQ-ACK, that is, category-1 HARQ-ACK).

### Overview of Embodiment

Hereinafter, in order to solve the above-described problem, methods of specifying the PUCCH cell for HARQ-ACK for subsequent SPS-PDSCH without DCI will be described. Hereinafter, Embodiment 1 and Embodiment 2 will be described as specific examples.

### Embodiment 1

According to this embodiment, an example of determining how to specify the PUCCH cell for HARQ-ACK for SPS-PDSCH without DCI, in a case where the K1 value for SPS-PDSCH without DCI is interpreted by the PUCCH cell indicated by the PUCCH cell indication field of the SPS activation DCI, will be described. Note that the K1 value is a parameter that indicates the time interval from PDSCH to HARQ-ACK using the number of slots as a unit.

### (Option 1)

The terminal 20 may transmit the HARQ-ACK for SPS-PDSCH without DCI in the PUCCH cell indicated by the SPS activation DCI.

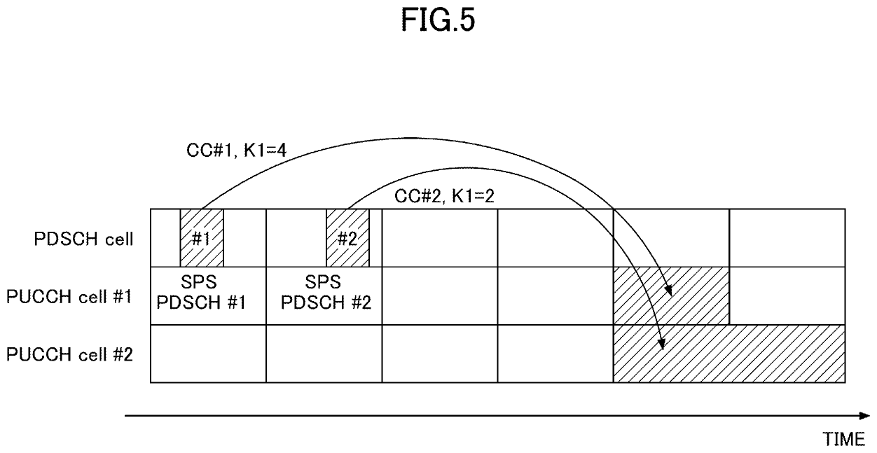

FIG. 5 is a drawing illustrating a method of determining the HARQ-ACK cell related to Option 1 in Embodiment 1. The terminal 20 transmits HARQ-ACK for SPS-PDSCH #1 and SPS-PDSCH #2 in the PUCCH cell indicated by the SPS activation DCI.

According to Option 1, the cell for transmitting the HARQ-ACK is the same as the cell for interpreting the K1 value, and thus, it is simpler than Option 2 described below.

With respect to the determination of HARQ-ACK multiplexing according to Option 1, it is more complicated than Option 2 described below. Specifically, regarding multiplexing or overlapping with respect to HARQ-ACKs between different cells, in a case where one of overlapping cells is indicated by DCI, it is necessary for the terminal 20 to handle overlapping of three or more cells. This is because it is difficult to avoid SPS-HARQ-ACK overlapping in different cells for SPS-HARQ-ACK without DCI. Note that details of such multiplexing processing will be described later as Embodiment 2.

### (Option 2)

The terminal 20 may transmit the HARQ-ACK for SPS-PDSCH without DCI in the default cell (Pcell/PSCell/PUCCH-Scell, cells configured by RRC, etc.).

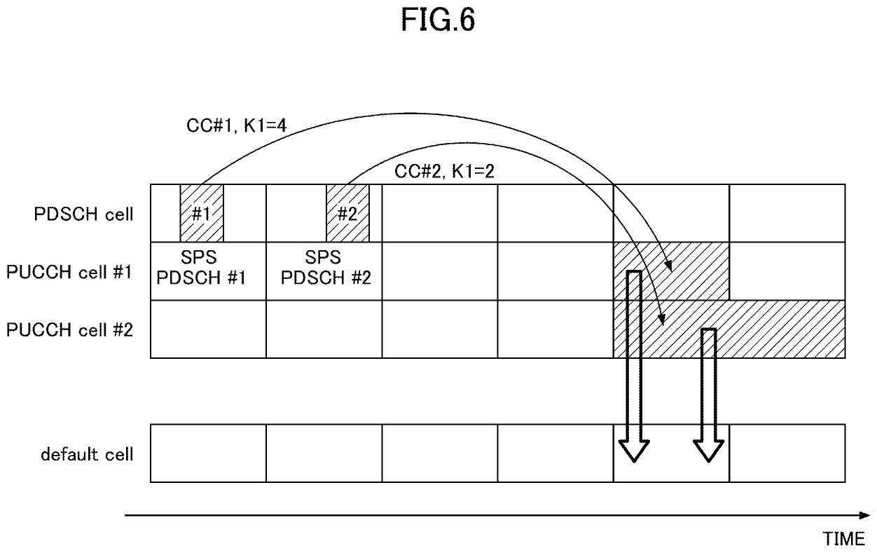

FIG. 6 is a drawing illustrating a method of determining the HARQ-ACK cell related to Option 2 in Embodiment 1. The terminal 20 transmits the HARQ-ACK for SPS-PDSCH #1 and SPS-PDSCH #2 in the default cell. The transmission slot of the default cell is the slot that overlaps with the HARQ-ACK reporting slot interpreted based on the PUCCH cell indicated by the SPS activation DCI.

The HARQ-ACK transmission slot of the default cell is a slot that overlaps with the HARQ-ACK timing slot determined by the K1 value of the PUCCH cell indicated by the SPS activation DCI.

In a case where the terminal 20 determines that the subcarrier spacing of the default cell is greater than the subcarrier spacing of the PUCCH cell indicated by the SPS activation DCI, i.e., that multiple slots of the default cell overlap with the HARQ-ACK timing slots determined in the PUCCH cell indicated by the SPS activation DCI, the first or last overlapping slot, or a slot with a slot offset configured by RRC with respect to the first or last overlapping slot of the default cell, may be determined as the HARQ-ACK transmission slot.

The following variations of limitations may be added to the method of determining the HARQ-ACK cell related to Option 2.

As a first variation, the terminal 20 may assume that SPS-HARQ-ACKs in different slots of the same PUCCH cell are not associated with the same slot of the default cell.

As a second variation, the terminal 20 may assume that SPS-HARQ-ACKs of non-overlapping slots in the same or different cells are not associated with the same slot in the default cell.

According to Option 2, HARQ-ACK multiplexing can be determined more easily than Option 1. This is because, in a case where multiplexing or overlapping of HARQ-ACKs is performed in different cells, only the overlapping in two cells, i.e., the dynamically indicated PUCCH cell and the default PUCCH cell, needs to be processed.

Note that in Option 2, the mapping from the PUCCH cell indicated by the SPS activation DCI to the default cell is required to determine the HARQ-ACK transmission slot of the default cell.

### Embodiment 2

In this embodiment, how to multiplex HARQ-ACKs included in different cells in Option 1 related to Embodiment 1, will be described.

The terminal 20 first multiplexes HARQ-ACKs in the same slot in the same cell. And then, 4 cases for the terminal 20 to multiplex HARQ-ACKs of different cells, will be described.

### (Case 1)

Case 1 is a case of category-1 HARQ-ACK in different cells.

In Case 1, the terminal 20 may determine the PUCCH cell for the HARQ-ACK multiplexed from different cells by one of the following alternatives.

### (Alternative 1-1)

The terminal 20 may determine the PUCCH cell for the HARQ-ACK multiplexed from different cells to be one of the following.

That is, the terminal 20 may determine the PUCCH cell for the HARQ-ACK to be a cell of SPS-PDSCH with the largest or smallest SPS configuration index among all of the SPS-PDSCHs associated with the overlapping HARQ-ACK slots.

In addition, the terminal 20 may determine the PUCCH cell for the HARQ-ACK to be a cell of SPS-PDSCH configured to a cell with the smallest or largest cell index among all of the SPS-PDSCHs associated with the overlapping HARQ-ACK slots.

In addition, the terminal 20 may determine the PUCCH cell for the HARQ-ACK to be a cell of SPS-PDSCH with the last or first start or end symbol among all of the SPS-PDSCHs associated with the overlapping HARQ-ACK slots.

Alternatively, the terminal 20 may determine the PUCCH cell for the HARQ-ACK to be a cell of SPS-PDSCH from which the SPS activation DCI is first or last received among all of the SPS-PDSCHs associated with the overlapping HARQ-ACK slots.

### (Alternative 1-2)

The terminal 20 may determine the PUCCH cell for the HARQ-ACK multiplexed from different cells to be one of the following.

That is, the terminal 20 may determine the PUCCH cell for the HARQ-ACK to be a PUCCH cell with the smallest or largest cell index among the overlapping HARQ-ACK slots in the multiple PUCCH cells.

In addition, the terminal 20 may determine the PUCCH cell for the HARQ-ACK to be a cell with the first or last HARQ-ACK slot among the overlapping HARQ-ACK slots in the multiple PUCCH cells.

Furthermore, the terminal 20 may determine the PUCCH cell for the HARQ-ACK to be a cell with minimum or maximum subcarrier spacing among the overlapping HARQ-ACK slots in the multiple PUCCH cells.

In addition, in Case 1, the terminal 20 may generate a HARQ-ACK codebook by one of the following optional methods:

### (Option 1-A)

The terminal 20 may separately generate HARQ-ACK codebooks and then combine them. In this case, the terminal 20 may individually generate HARQ-ACK codebooks in different cells. Here, the terminal 20 may generate each HARQ-ACK codebook, based on the rules of NR release 16.

The terminal 20 may combine multiple generated HARQ-ACK codebooks, based on the HARQ-ACK slot index and/or PUCCH cell index.

### (Option 1-B)

The terminal 20 may mix HARQ-ACK codebooks to generate the mixed HARQ-ACK codebook. The SPS-HARQ-ACK bits for all bits in the multiplexed codebook may be ordered by the terminal 20: by reusing the ordering rules of NR release 16; i.e., based on the SPS configuration index and SPS-PDSCH cells.

### (Case 2)

Case 2 is a case in which category-1 HARQ-ACK and category-3 HARQ-ACK are included in different cells.

In Case 2, the multiplexing method of HARQ-ACKs may be one of the following.

### (Alternative 2-1)

The terminal 20 may multiplex HARQ-ACKs in the following 2-step procedure.

In the first step, the terminal 20 uses a method of Case 1 for resolving overlapping or multiplexing between category-1 HARQ-ACKs.

In the second step, in a case where the multiplexed category-1 HARQ-ACK as a result of the first step overlaps with the category-3 HARQ-ACK, the terminal 20 resolves the overlapping.

### (Alternative 2-2)

The terminal 20 may resolve the overlapping between the category-1 HARQ-ACK and the category-3 HARQ-ACK in one step.

In Case 2, the method of determining the PUCCH cell for multiplexed category-1 HARQ-ACK and category-3 HARQ-ACK, may be one of the following.

### (Alternative 2-A)

The terminal 20 performs determination according to the PUCCH cell for category-1 HARQ-ACK by utilizing Alternative 1-1 and Alternative 1-2 of Case 1.

### (Alternative 2-B)

The terminal 20 performs determination according to the PUCCH cell for category-3 HARQ-ACK. In Case 2, the terminal 20 may generate a HARQ-ACK codebook by one of the following optional methods.

### (Option 2-A)

The terminal 20 may separately generate HARQ-ACK codebooks and then combine them. In this case, the terminal 20 may individually generate HARQ-ACK codebooks in different cells. Here, the terminal 20 may generate each HARQ-ACK codebook, based on the rules of NR release 16.

The terminal 20 may combine multiple generated HARQ-ACK codebooks, based on the HARQ-ACK slot index and/or PUCCH cell index.

### (Option 2-B)

The terminal 20 may mix HARQ-ACK codebooks to generate the mixed HARQ-ACK codebook. The SPS-HARQ-ACK bits for all bits in the multiplexed codebook may be ordered by the terminal 20: by reusing the ordering rules of NR release 16; i.e., based on the SPS configuration index and SPS-PDSCH cells.

### (Option 2-C)

A category-1 HARQ-ACK codebook and a category-3 HARQ-ACK codebook may be separately generated by the terminal 20, and the category-1 HARQ-ACK codebook may be mixed to generate the mixed codebook.

In this case, the category-1 HARQ-ACK codebook may be mixed and ordered by the terminal 20, based on the method of Option 1-B in Case 1. In addition, the terminal 20 may individually generate the category-3 HARQ-ACK codebook, based on the procedure in Release 16. In addition, the terminal 20 may add the category-1 HARQ-ACK codebook after the category-3 HARQ-ACK codebook, or add the category-3 HARQ-ACK codebook after the category-1 HARQ-ACK codebook.

### (Case 3)

Case 3 is a case in which category-1 HARQ-ACK and category-2 HARQ-ACK are included in different cells.

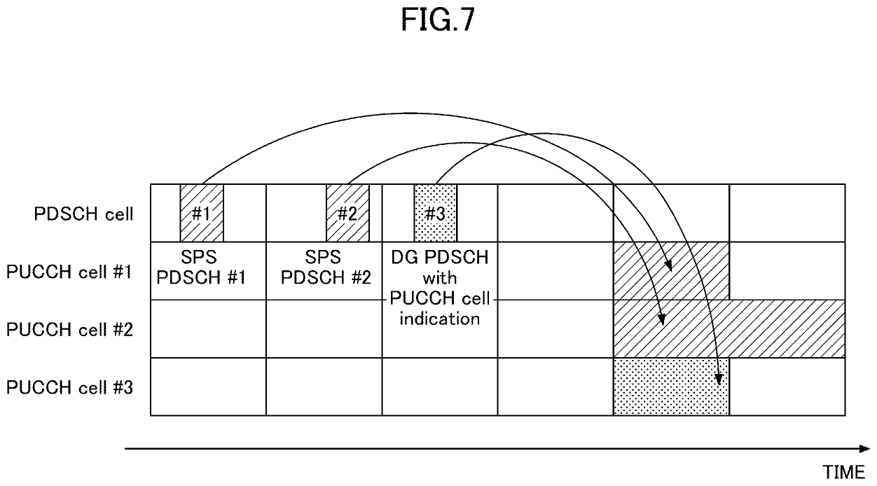

FIG. 7 is a drawing illustrating a method of determining the HARQ-ACK cell related to Case 3 in Embodiment 2.

In Case 3, the multiplexing method of HARQ-ACKs may be one of the following.

### (Alternative 3-1)

The terminal 20 may multiplex HARQ-ACKs in the following 2-step procedure.

In the first step, the terminal 20 uses a method of Case 1 for resolving overlapping or multiplexing between category-1 HARQ-ACKs.

In the second step, in a case where the multiplexed category-1 HARQ-ACK as a result of the first step overlaps with the category-2 HARQ-ACK, the terminal 20 resolves the overlapping.

### (Alternative 3-2)

The terminal 20 may resolve the overlapping between the category-1 HARQ-ACK and the category-2 HARQ-ACK in one step.

In Case 3, the method of determining the PUCCH cell for multiplexed category-1 HARQ-ACK and category-2 HARQ-ACK, may be one of the following.

### (Alternative 3-A)

The terminal 20 may perform determination according to the PUCCH cell for category-1 HARQ-ACK by utilizing Alternative 1-1 and Alternative 1-2 of Case 1.

### (Alternative 3-B)

The terminal 20 may perform determination according to the PUCCH cell for category-2 HARQ-ACK.

In Case 3, the terminal 20 may generate a HARQ-ACK codebook by one of the following optional methods.

### (Option 3-A)

The terminal 20 may separately generate HARQ-ACK codebooks and then combine them. In this case, the terminal 20 may individually generate HARQ-ACK codebooks in different cells. Here, the terminal 20 may generate each HARQ-ACK codebook, based on the rules of NR release 16.

The terminal 20 may combine multiple generated HARQ-ACK codebooks, based on the HARQ-ACK slot index and/or PUCCH cell index.

### (Option 3-B)

The terminal 20 may mix HARQ-ACK codebooks to generate the mixed HARQ-ACK codebook. The SPS-HARQ-ACK bits for all bits in the multiplexed codebook may be ordered by the terminal 20: by reusing the ordering rules of NR release 16; i.e., based on the SPS configuration index and SPS-PDSCH cells.

### (Option 3-C)

A category-1 HARQ-ACK codebook and a category-2 HARQ-ACK codebook may be separately generated by the terminal 20, and the category-1 HARQ-ACK codebook may be mixed to generate the mixed codebook.

In this case, the category-1 HARQ-ACK codebook may be mixed and ordered by the terminal 20, based on the method of Option 1-B of Case 1. In addition, the terminal 20 may individually generate the category-2 HARQ-ACK codebook, based on the procedure in Release 16. In addition, the terminal 20 may add the category-1 HARQ-ACK codebook after the category-2 HARQ-ACK codebook, or add the category-2 HARQ-ACK codebook after the category-1 HARQ-ACK codebook.

### (Case 4)

Case 4 is a case in which category-1 HARQ-ACK, category-2 HARQ-ACK, and category-3 HARQ-ACK are included in different cells.

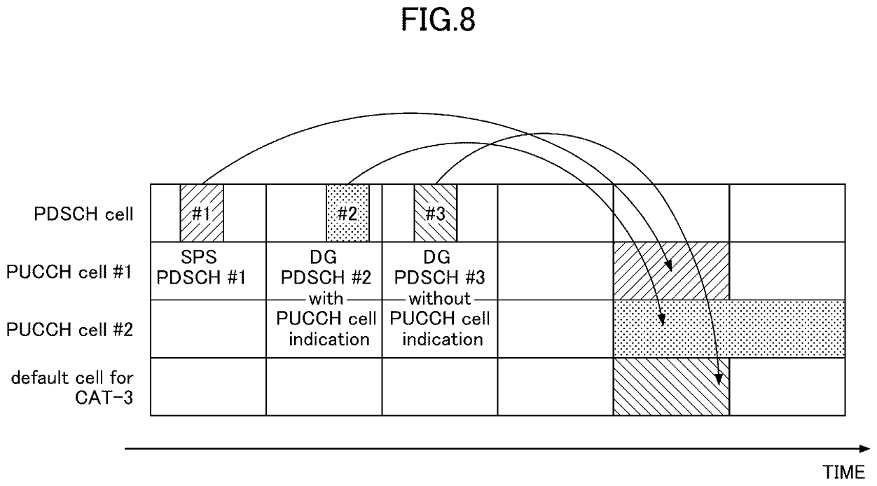

FIG. 8 is a drawing illustrating a method of determining the HARQ-ACK cell related to Case 4 in Embodiment 2.

In Case 3, the multiplexing method of HARQ-ACKs may be one of the following.

### (Alternative 4-1)

The terminal 20 may multiplex HARQ-ACKs in the following 3-step procedure.

### (Alternative 4-1A)

In the first step, the terminal 20 uses a method of Case 1 for resolving overlapping or multiplexing between category-1 HARQ-ACKs.

In the second step, in a case where the multiplexed category-1 HARQ-ACK as a result of the first step overlaps with the category-2 HARQ-ACK, the terminal 20 resolves the overlapping, based on a method of Case 3.

In the third step, in a case where the multiplexed HARQ as a result of the second step overlaps with the category-3 HARQ-ACK, the terminal 20 resolves the overlapping.

### (Alternative 4-1B)

In the first step, the terminal 20 uses a method of Case 2 for resolving overlapping or multiplexing between category-1 HARQ-ACKs.

In the second step, in a case where the multiplexed category-1 HARQ-ACK as a result of the first step overlaps with the category-3 HARQ-ACK, the terminal 20 resolves the overlapping, based on a method of Case 2.

In the third step, in a case where the multiplexed HARQ as a result of the second step overlaps with the category-2 HARQ-ACK, the terminal 20 resolves the overlapping.

### (Alternative 4-2)

The terminal 20 may multiplex HARQ-ACKs in the following 2-step procedure.

### (Alternative 4-2A)

In the first step, the terminal 20 uses a method of Case 1 for resolving overlapping or multiplexing between category-1 HARQ-ACKs.

In the second step, in a case where the multiplexed category-1 HARQ-ACK as a result of the first step, the category-2 HARQ-ACK, and the category-3 HARQ-ACK overlap with each other, the terminal 20 resolves the overlapping.

### (Alternative 4-2B)

In the first step, the terminal 20 uses a method of Case 3 for resolving overlapping between the category-1 HARQ-ACK and the category-2 HARQ-ACK.

In the second step, in a case where the multiplexed HARQ-ACK as a result of the first step overlaps with the category-3 HARQ-ACK, the terminal 20 resolves the overlapping.

### (Alternative 4-2C)

In the first step, the terminal 20 uses a method of Case 2 for resolving overlapping between the category-1 HARQ-ACK and the category-3 HARQ-ACK.

In the second step, in a case where the multiplexed HARQ-ACK as a result of the first step overlaps with the category-2 HARQ-ACK, the terminal 20 resolves the overlapping.

### (Alternative 4-3)

The terminal 20 may resolve the overlapping among the category-1 HARQ-ACK, the category-2 HARQ-ACK, and the category-3 HARQ-ACK in one step.

In Case 4, the method of determining the PUCCH cell for multiplexed category-1 HARQ-ACK, the category-2 HARQ-ACK, and the category-3 HARQ-ACK, may be one of the following.

### (Alternative 4-A)

The terminal 20 may perform determination according to the PUCCH cell for category-1 HARQ-ACK by utilizing Alternative 1-1 and Alternative 1-2 of Case 1.

### (Alternative 4-B)

The terminal 20 may perform determination according to the PUCCH cell for category-2 HARQ-ACK.

### (Alternative 4-C)

The terminal 20 may perform determination according to the PUCCH cell for the category-3 HARQ-ACK.

In Case 4, the terminal 20 may generate a HARQ-ACK codebook by one of the following optional methods.

### (Option 4-A)

The terminal 20 may separately generate HARQ-ACK codebooks and then combine them. In this case, the terminal 20 may individually generate HARQ-ACK codebooks in different cells. Here, the terminal 20 may generate each HARQ-ACK codebook, based on the rules of NR release 16.

The terminal 20 may combine multiple generated HARQ-ACK codebooks, based on the HARQ-ACK slot index and/or PUCCH cell index.

In addition, the terminal 20 may count DAI (Downlink Assignment Index) for dynamic HARQ-ACKs in different cells individually.

### (Option 4-B)

The terminal 20 may mix all HARQ-ACK codebooks to generate the mixed HARQ-ACK codebook. The SPS-HARQ-ACK bits for all bits in the multiplexed codebook may be ordered by the terminal 20: by reusing the ordering rules of NR release 16; i.e., based on the SPS configuration index and SPS-PDSCH cells.

In addition, the terminal 20 may integrally count the DAI for dynamic HARQ-ACKs in different cells, based on the entire multiplexed HARQ-ACK codebook.

### (Option 4-C)

The terminal 20 may partially mix HARQ-ACK codebooks to generate the mixed HARQ-ACK codebook.

### (Option 4-C1)

The terminal 20 may mix category-1 HARQ-ACK codebooks to generate the mixed HARQ-ACK codebook, and may individually generate the category-2 HARQ-ACK codebook and the category-3 HARQ-ACK codebook.

The category-1 HARQ-ACK codebooks may be mixed and ordered by the terminal 20, based on the method of Option 1-B in Case 1. In addition, the terminal 20 may individually generate the category-2 HARQ-ACK codebook, based on the procedure in Release 16. In addition, the terminal 20 may individually generate the category-3 HARQ-ACK codebook, based on the procedure in Release 16.

Further, the category-1 HARQ-ACK codebook, the category-2 HARQ-ACK codebook, and the category-3 HARQ-ACK codebook may be concatenated by the terminal 20 with any possible order. For example, the order may be [category-1, category-2, category-3], [category-1, category-3, category-2], [category-2, category-3, category-1], [category-2, category-1, category-3], [category-3, category-2, category-1], [category-3, category-1, category-2], etc.

### (Option 4-C2)

The terminal 20 may mix the category-1 HARQ-ACK codebook and the category-2 HARQ-ACK codebook to generate the mixed HARQ-ACK codebook, and may separately generate the category-3 HARQ-ACK codebook.

The terminal 20 may generate the category-1 HARQ-ACK codebook and the category-2 HARQ-ACK codebook, based on a method of Option 3-A, Option 3-B, or Option 3-C in Case 3. Hereafter, the generated HARQ-ACK codebook is defined as a category-12 HARQ-ACK codebook.

In addition, the terminal 20 may separately generate the category-3 HARQ-ACK codebook, based on the procedure in Release 16. Further, the generated category-12 HARQ-ACK codebook and the category-3 HARQ-ACK codebook may be concatenated by the terminal 20 in any possible order. For example, the order may be [category-12, category-3], [category-3, category-12], etc.

### (Option 4-C3)

The terminal 20 may mix the category-1 HARQ-ACK codebook and the category-3 HARQ-ACK codebook to generate the mixed HARQ-ACK codebook, and may separately generate the category-2 HARQ-ACK codebook.

The terminal 20 may generate the category-1 HARQ-ACK codebook and the category-3 HARQ-ACK codebook, based on a method of Option 2-A, Option 2-B, or Option 2-C in Case 2. Hereafter, the generated HARQ-ACK codebook is defined as a category-13 HARQ-ACK codebook.

In addition, the terminal 20 may individually generate the category-2 HARQ-ACK codebook, based on the procedure in Release 16. Further, the generated category-13 HARQ-ACK codebook and the category-2 HARQ-ACK codebook may be concatenated by the terminal 20 in any possible order. For example, the order may be [category-13, category-2], [category-2, category-13], etc.

### (Option 4-C4)

The terminal 20 may mix category-1 HARQ-ACK codebooks to generate the mixed HARQ-ACK codebook, and may individually generate the category-2 HARQ-ACK codebook and the category-3 HARQ-ACK codebook.

The category-1 HARQ-ACK codebooks may be mixed and ordered by the terminal 20, based on the method of Option 1-B in Case 1.

In addition, the terminal 20 may generate the category-2 HARQ-ACK codebook and the category-3 HARQ-ACK codebook. Hereafter, the generated HARQ-ACK codebook is defined as a category-23 HARQ-ACK codebook.

Further, the generated category-1 HARQ-ACK codebook and the category-23 HARQ-ACK codebook may be concatenated by the terminal 20 in any possible order. For example, the order may be [category-1, category-23], [category-23, category-1], etc.

In each of the above embodiments, which of the options is available may be configured by an upper layer parameter, may be indicated as a terminal capability by the terminal 20 to the base station 10, may be specified in technical specifications, or may be determined by the configuration by the upper layer parameter and the indicated terminal capability (a combination thereof).

In each of the above embodiments, “slot” may be replaced by “subslot”.

In a case where semi-static PUCCH carrier switching is enabled, the PUCCH cell in each embodiment for category-1 HARQ-ACK and/or category-3 HARQ-ACK may be a cell before or after the semi-static PUCCH carrier switching.

Information indicating whether the terminal 20 supports PUCCH carrier switching may be defined as a terminal capability (UE Capability).

In addition, information indicating whether the terminal 20 supports overlapping or multiplexing of dynamic HARQ-ACK slots in different carriers may be defined as a terminal capability (UE Capability).

In addition, information indicating whether the terminal 20 supports overlapping or multiplexing of SPS-HARQ-ACK slots in different carriers may be defined as a terminal capability (UE Capability).

In addition, information indicating whether the terminal 20 supports overlapping or multiplexing of dynamic HARQ-ACK slots and SPS-HARQ-ACK slots in different carriers may be defined as a terminal capability (UE Capability).

### (Apparatus Configuration)

Next, a functional configuration example of the base station 10 and the terminal 20 for performing the processes and operations described above will be described. The base station 10 and the terminal 20 include functions for implementing the embodiments described above. It should be noted, however, that each of the base stations 10 and the terminal 20 may include only proposed functions in one of the embodiments.

### <Base Station 10>

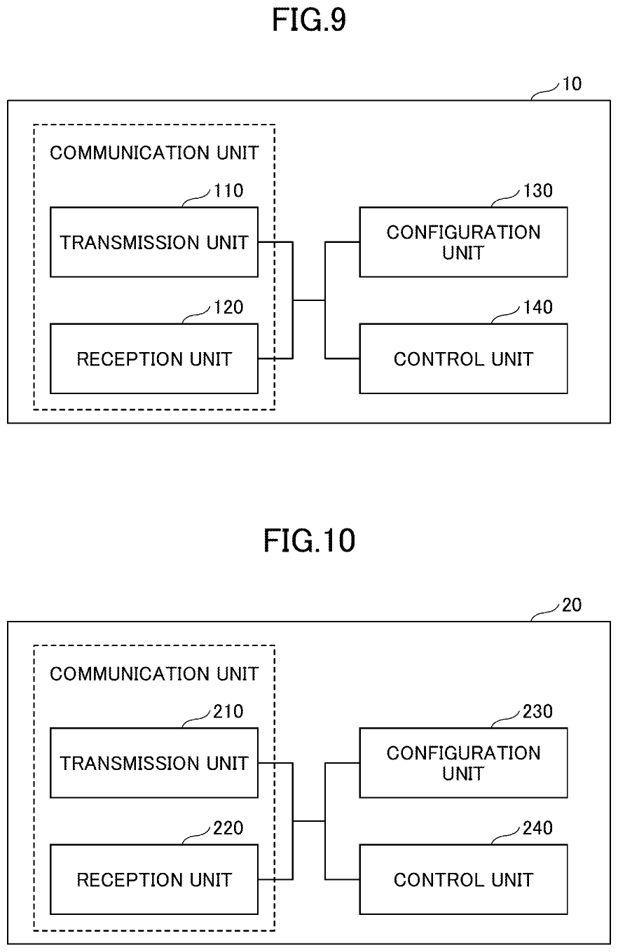

FIG. 9 is a diagram illustrating an example of a functional configuration of the base station 10. As shown in FIG. 9, the base station 10 includes a transmission unit 110, a reception unit 120, a configuration unit 130, and a control unit 140. The functional structure illustrated in FIG. 9 is merely an example. Functional divisions and names of functional units may be anything as long as operations according to an embodiment of the present invention can be performed. The transmission unit 110 and the reception unit 120 may be referred to as a communication unit.

The transmission unit 110 includes a function for generating a signal to be transmitted to the terminal 20 side and transmitting the signal wirelessly. The reception unit 120 includes a function for receiving various signals transmitted from the terminal 20 and acquiring, for example, information of a higher layer from the received signals. Further, the transmission unit 110 has a function of transmitting NR-PSS, NR-SSS, NR-PBCH, DL/UL control signals, the DL data, and the like, to the terminal 20. In addition, the transmission unit 110 transmits configuration information, or the like, described in the embodiment.

The configuration unit 130 stores preset configuration information and various configuration information items to be transmitted to the terminal 20 in a storage device and reads the preset configuration information from the storage device if necessary. The control unit 140 controls the entire base station 10 including, for example, control of signal transmission and reception. Note the functional unit related to signal transmission in the control unit 140 may be included in the transmission unit 110, and the functional unit related to signal reception in the control unit 140 may be included in the reception unit 120. Further, the transmission unit 110 and the reception unit 120 may be referred to as a transmitter and a receiver, respectively.

### <Terminal 20>

FIG. 10 is a diagram illustrating an example of a functional configuration of the terminal 20. As shown in FIG. 10, the terminal 20 includes a transmission unit 210, a reception unit 220, a configuration unit 230, and a control unit 240. The functional structure illustrated in FIG. 10 is merely an example. Functional divisions and names of functional units may be anything as long as operations according to an embodiment of the present invention can be performed. The transmission unit 210 and the reception unit 220 may be referred to as a communication unit.

The transmission unit 210 generates a transmission signal from transmission data and transmits the transmission signal wirelessly. The reception unit 220 receives various signals wirelessly and obtains upper layer signals from the received physical layer signals. In addition, the transmission unit 210 transmits a HARQ-ACK, and the reception unit 220 receives configuration information described in the embodiment.

The configuration unit 230 stores, in a storage device, various configuration information items received from the base station 10 via the reception unit 220, and reads them from the storage device if necessary. In addition, the configuration unit 230 stores pre-configured configuration information. The control unit 240 controls the entire terminal 20 including control related to signal transmission and reception. Note the functional unit related to signal transmission in the control unit 240 may be included in the transmission unit 210, and the functional unit related to signal reception in the control unit 240 may be included in the reception unit 220. Further, the transmission unit 210 and the reception unit 220 may be referred to as a transmitter and a receiver, respectively.

The terminal or base station according to an embodiment of the present invention may be configured as a terminal or a base station described in the following paragraphs. In addition, a communication method below may be performed.

### Configuration Related to an Embodiment of the Present Invention

### (First Item)

A terminal comprising:
a reception unit configured to receive downlink control information activating semi-persistent scheduling and downlink data according to the activated semi-persistent scheduling from a base station;
a control unit configured to determine a cell for feedback for the downlink data in a case where dynamic carrier switching is enabled; and
a transmission unit configured to use the determined cell to transmit feedback information corresponding to the downlink data to the base station.

### (Second Item)

The terminal according to the first item, wherein the control unit determines the cell for feedback for the downlink data, based on the downlink control information activating the semi-persistent scheduling.

### (Third Item)

The terminal according to the second item, wherein the control unit multiplexes multiple pieces of feedback information included in different cells, and
the transmission unit uses the cell to transmit the multiplexed pieces of feedback information to the base station.

### (Fourth Item)

The terminal according to the first item, wherein the control unit determines the cell for feedback for the downlink data to be a default cell that is specified in advance.

### (Fifth Item)

A base station comprising:
a transmission unit configured to transmit downlink control information activating semi-persistent scheduling and downlink data according to the activated semi-persistent scheduling to a terminal;
a control unit configured to determine a cell for feedback corresponding to the downlink data in a case where dynamic carrier switching is enabled; and
a reception unit configured to use the determined cell to receive feedback information corresponding to the downlink data from the terminal.

### (Sixth Item)

A communication method executed by a terminal, the communication method comprising:
receiving downlink control information activating semi-persistent scheduling and downlink data according to the activated semi-persistent scheduling from a base station;
determining a cell for feedback for the downlink data in a case where dynamic carrier switching is enabled; and
using the determined cell to transmit feedback information corresponding to the downlink data to the base station.

According to any one of the above configurations, a technique is provided that enables to specify a cell for feedback for downlink data according to semi-persistent scheduling in a case where dynamic carrier switching is enabled. According to the second item, specifying a cell for feedback can be implemented by a simple method. According to the third item, multiplexing of feedback information pieces in different cells can be implemented. According to the fourth item, specifying a cell for feedback can be implemented by a method in which it is easy to multiplex feedback information pieces.

### (Hardware Structure)

In the above functional structure diagrams used for describing an embodiment of the present invention (FIG. 9 and FIG. 10), functional unit blocks are shown. The functional blocks (function units) are realized by a freely-selected combination of hardware and/or software. Further, realizing means of each functional block is not limited in particular. In other words, each functional block may be realized by a single apparatus in which multiple elements are coupled physically and/or logically, or may be realized by two or more apparatuses that are physically and/or logically separated and are physically and/or logically connected (e.g., wired and/or wireless). The functional blocks may be realized by combining the above-described one or more apparatuses with software.

Functions include, but are not limited to, judging, determining, calculating, processing, deriving, investigating, searching, checking, receiving, transmitting, outputting, accessing, resolving, selecting, establishing, comparing, assuming, expecting, and deeming; broadcasting, notifying, communicating, forwarding, configuring, reconfiguring, allocating, mapping, and assigning, etc. For example, a functional block (component) that functions to transmit is called a transmitting unit or a transmitter. In either case, as described above, the implementation method is not particularly limited.

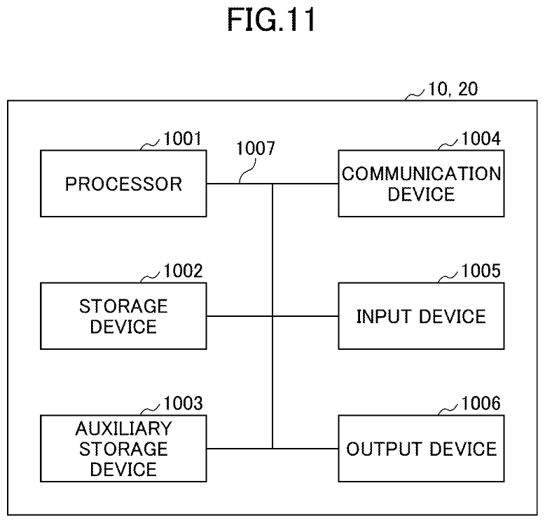

For example, the base station 10, terminal 20, etc., according to an embodiment of the present disclosure may function as a computer for processing the radio communication method of the present disclosure. FIG. 11 is a drawing illustrating an example of hardware structures of the base station 10 and the terminal 20 according to an embodiment of the present invention. Each of the above-described base station 10 and the terminal 20 may be physically a computer device including a processor 1001, a storage device 1002, an auxiliary storage device 1003, a communication device 1004, an input device 1005, an output device 1006, a bus 1007, etc.

It should be noted that, in the descriptions below, the term “apparatus” can be read as a circuit, a device, a unit, etc. The hardware structures of the base station 10 and the terminal 20 may include one or more of each of the devices illustrated in the figure, or may not include some devices.

Each function in the base station 10 and the terminal 20 is realized by having the processor 1001 perform an operation by reading predetermined software (programs) onto hardware such as the processor 1001 and the storage device 1002, and by controlling communication by the communication device 1004 and controlling at least one of reading and writing of data in the storage device 1002 and the auxiliary storage device 1003.

The processor 1001 controls the entire computer by, for example, controlling the operating system. The processor 1001 may include a central processing unit (CPU) including an interface with a peripheral apparatus, a control apparatus, a calculation apparatus, a register, etc. For example, the above-described control unit 140, control unit 240, and the like, may be implemented by the processor 1001.

Further, the processor 1001 reads a program (program code), a software module, or data from the auxiliary storage device 1003 and/or the communication device 1004 to the storage device 1002, and performs various processes according to the program, the software module, or the data. As the program, a program is used that causes the computer to perform at least a part of operations according to an embodiment of the present invention described above. For example, the control unit 140 of the base station 10 illustrated in FIG. 9 may be realized by control programs that are stored in the storage device 1002 and are executed by the processor 1001. Further, for example, the control unit 240 of the terminal 20 illustrated in FIG. 10 may be realized by control programs that are stored in the storage device 1002 and are executed by the processor 1001. The various processes have been described to be performed by a single processor 1001. However, the processes may be performed by two or more processors 1001 simultaneously or sequentially. The processor 1001 may be implemented by one or more chips. It should be noted that the program may be transmitted from a network via a telecommunication line.

The storage device 1002 is a computer-readable recording medium, and may include at least one of a ROM (Read Only Memory), an EPROM (Erasable Programmable ROM), an EEPROM (Electrically Erasable Programmable ROM), a RAM (Random Access Memory), etc. The storage device 1002 may be referred to as a register, a cache, a main memory, etc. The storage device 1002 is capable of storing programs (program codes), software modules, or the like, that are executable for performing communication processes according to an embodiment of the present invention.

The auxiliary storage device 1003 is a computer-readable recording medium, and may include at least one of, for example, an optical disk such as a CD-ROM (Compact Disc ROM), a hard disk drive, a flexible disk, a magneto optical disk (e.g., compact disk, digital versatile disk, Blu-ray (registered trademark) disk), a smart card, a flash memory (e.g., card, stick, key drive), a floppy (registered trademark) disk, a magnetic strip, etc. The above recording medium may be a database including the storage device 1002 and/or the auxiliary storage device 1003, a server, or any other appropriate medium.

The communication device 1004 is hardware (transmission and reception device) for communicating with computers via at least one of a wired network and a wireless network, and may be referred to as a network device, a network controller, a network card, a communication module, etc. The communication device 1004 may comprise a high frequency switch, duplexer, filter, frequency synthesizer, or the like, for example, to implement at least one of a frequency division duplex (FDD) and a time division duplex (TDD). For example, the transmitting/receiving antenna, the amplifier unit, the transmitting/receiving unit, the transmission line interface, and the like, may be implemented by the communication device 1004. The transmitting/receiving unit may be physically or logically divided into a transmitting unit and a receiving unit.

The input device 1005 is an input device that receives an external input (e.g., keyboard, mouse, microphone, switch, button, sensor). The output device 1006 is an output device that outputs something to the outside (e.g., display, speaker, LED lamp). It should be noted that the input device 1005 and the output device 1006 may be integrated into a single device (e.g., touch panel).

Further, the apparatuses including the processor 1001, the storage device 1002, etc., are connected to each other via the bus 1007 used for communicating information. The bus 1007 may include a single bus, or may include different buses between the apparatuses.

Further, each of the base station 10 and terminal 20 may include hardware such as a micro processor, a digital signal processor (DSP), an ASIC (Application Specific Integrated Circuit), a PLD (Programmable Logic Device), a FPGA (Field Programmable Gate Array), etc., and a part or all of each functional block may be realized by the hardware. For example, the processor 1001 may be implemented by at least one of the above hardware elements.

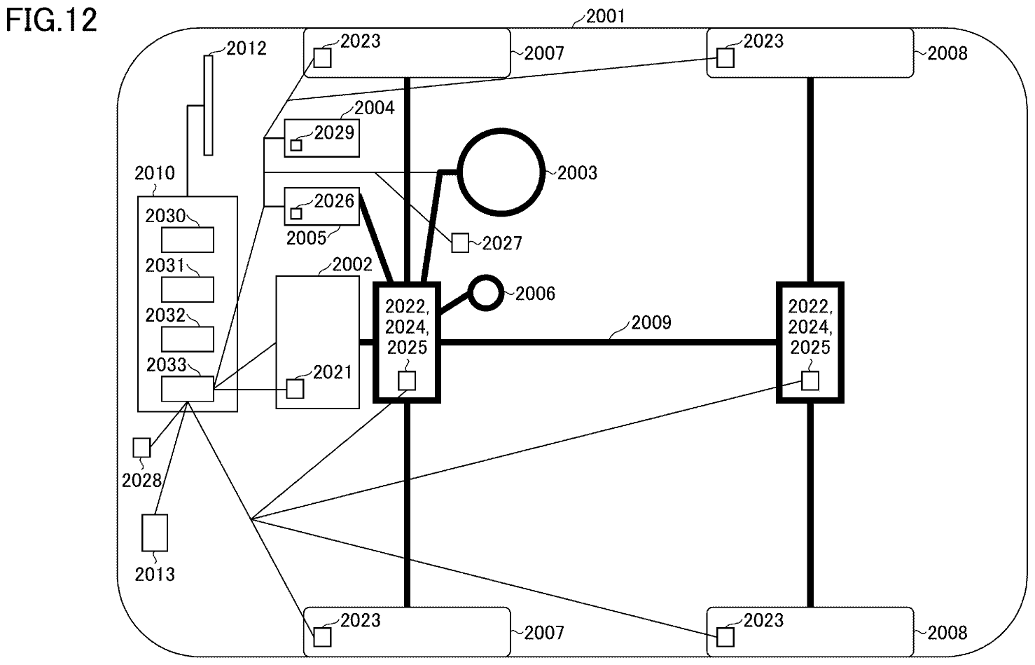

FIG. 12 shows an example of a configuration of a vehicle 2001. As shown in FIG. 12, the vehicle 2001 includes a drive unit 2002, a steering unit 2003, an accelerator pedal 2004, a brake pedal 2005, a shift lever 2006, a front wheel 2007, a rear wheel 2008, an axle 2009, an electronic control unit 2010, various sensors 2021-2029, an information service unit 2012, and a communication module 2013. The aspects/embodiments described in the present disclosure may be applied to a communication device mounted in the vehicle 2001, and may be applied to, for example, the communication module 2013.

The drive unit 2002 may include, for example, an engine, a motor, and a hybrid of an engine and a motor. The steering unit 2003 includes at least a steering wheel and is configured to steer at least one of the front wheel and the rear wheel, based on the operation of the steering wheel operated by the user.

The electronic control unit 2010 includes a microprocessor 2031, a memory (ROM, RAM) 2032, and a communication port (IO port) 2033. The electronic control unit 2010 receives signals from the various sensors 2021-2029 provided in the vehicle 2001. The electronic control unit 2010 may be referred to as an ECU (Electronic control unit).

The signals from the various sensors 2021 to 2029 include a current signal from a current sensor 2021 which senses the current of the motor, a front or rear wheel rotation signal acquired by a revolution sensor 2022, a front or rear wheel pneumatic signal acquired by a pneumatic sensor 2023, a vehicle speed signal acquired by a vehicle speed sensor 2024, an acceleration signal acquired by an acceleration sensor 2025, an accelerator pedal stepped-in signal acquired by an accelerator pedal sensor 2029, a brake pedal stepped-in signal acquired by a brake pedal sensor 2026, an operation signal of a shift lever acquired by a shift lever sensor 2027, and a detection signal, acquired by the object detection sensor 2028, for detecting an obstacle, a vehicle, a pedestrian, and the like.

The information service unit 2012 includes various devices for providing various kinds of information such as driving information, traffic information, and entertainment information, including a car navigation system, an audio system, a speaker, a television, and a radio, and one or more ECUs controlling these devices. The information service unit 2012 provides various types of multimedia information and multimedia services to the occupants of the vehicle 2001 by using information obtained from the external device through the communication module 2013 or the like.

A driving support system unit 2030 includes: various devices for providing functions of preventing accidents and reducing a driver's operating burden such as a millimeter wave radar, a LIDAR (Light Detection and Ranging), a camera, a positioning locator (e.g., GNSS, etc.), map information (e.g., high definition (HD) map, autonomous vehicle (AV) map, etc.), a gyro system (e.g., IMU (Inertial Measurement Unit), INS (Inertial Navigation System), etc.), an AI (Artificial Intelligence) chip, an AI processor; and one or more ECUs controlling these devices. In addition, the driving support system unit 2030 transmits and receives various types of information via the communication module 2013 to realize a driving support function or an autonomous driving function.

The communication module 2013 may communicate with the microprocessor 2031 and components of the vehicle 2001 via a communication port. For example, the communication module 2013 transmits and receives data via a communication port 2033, to and from the drive unit 2002, the steering unit 2003, the accelerator pedal 2004, the brake pedal 2005, the shift lever 2006, the front wheel 2007, the rear wheel 2008, the axle 2009, the microprocessor 2031 and the memory (ROM, RAM) 2032 in the electronic control unit 2010, and sensors 2021-29 provided in the vehicle 2001.

The communication module 2013 is a communication device that can be controlled by the microprocessor 2031 of the electronic control unit 2010 and that is capable of communicating with external devices. For example, various kinds of information are transmitted to and received from external devices through radio communication. The communication module 2013 may be internal to or external to the electronic control unit 2010. The external devices may include, for example, a base station, a mobile station, or the like.

The communication module 2013 transmits a current signal, which is input to the electronic control unit 2010 from the current sensor, to the external devices through radio communication. In addition, the communication module 2013 also transmits, to the external devices through radio communication, the front or rear wheel rotation signal acquired by the revolution sensor 2022, the front or rear wheel pneumatic signal acquired by the pneumatic sensor 2023, the vehicle speed signal acquired by the vehicle speed sensor 2024, the acceleration signal acquired by the acceleration sensor 2025, the accelerator pedal stepped-in signal acquired by the accelerator pedal sensor 2029, the brake pedal stepped-in signal acquired by the brake pedal sensor 2026, the operation signal of the shift lever acquired by the shift lever sensor 2027, and the detection signal, acquired by the object detection sensor 2028, for detecting an obstacle, a vehicle, a pedestrian, and the like, that are input to the electronic control unit 2010.

The communication module 2013 receives various types of information (traffic information, signal information, inter-vehicle information, etc.) transmitted from the external devices and displays the received information on the information service unit 2012 provided in the vehicle 2001. In addition, the communication module 2013 stores the various types of information received from the external devices in the memory 2032 available to the microprocessor 2031. Based on the information stored in the memory 2032, the microprocessor 2031 may control the drive unit 2002, the steering unit 2003, the accelerator pedal 2004, the brake pedal 2005, the shift lever 2006, the front wheel 2007, the rear wheel 2008, the axle 2009, the sensors 2021-2029, etc., mounted in vehicle 2001.

### Supplement of Embodiment

As described above, one or more embodiments have been described. The present invention is not limited to the above embodiments. A person skilled in the art should understand that there are various modifications, variations, alternatives, replacements, etc., of the embodiments. In order to facilitate understanding of the present invention, specific values have been used in the description. However, unless otherwise specified, those values are merely examples and other appropriate values may be used. The division of the described items may not be essential to the present invention. The things that have been described in two or more items may be used in a combination if necessary, and the thing that has been described in one item may be appropriately applied to another item (as long as there is no contradiction). Boundaries of functional units or processing units in the functional block diagrams do not necessarily correspond to the boundaries of physical parts. Operations of multiple functional units may be physically performed by a single part, or an operation of a single functional unit may be physically performed by multiple parts. The order of sequences and flowcharts described in an embodiment of the present invention may be changed as long as there is no contradiction. For the sake of description convenience, the base station 10 and the terminal 20 have been described by using functional block diagrams. However, the apparatuses may be realized by hardware, software, or a combination of hardware and software. The software executed by a processor included in the base station 10 according to an embodiment of the present invention and the software executed by a processor included in the terminal 20 according to an embodiment of the present invention may be stored in a random access memory (RAM), a flash memory, a read only memory (ROM), an EPROM, an EEPROM, a register, a hard disk (HDD), a removable disk, a CD-ROM, a database, a server, or any other appropriate recording medium.

Further, information indication may be performed not only by methods described in an aspect/embodiment of the present specification but also a method other than those described in an aspect/embodiment of the present specification. For example, the information indication may be performed by physical layer signaling (e.g., DCI (Downlink Control Information), UCI (Uplink Control Information)), upper layer signaling (e.g., RRC (Radio Resource Control) signaling, MAC (Medium Access Control) signaling, broadcast information (MIB (Master Information Block), SIB (System Information Block))), other signals, or combinations thereof. Further, RRC signaling may be referred to as an RRC message. The RRC signaling may be, for example, an RRC connection setup message, an RRC connection reconfiguration message, or the like.

Each aspect/embodiment described in the present disclosure may be applied to at least one of a system using LTE (Long Term Evolution), LTE-A (LTE-Advanced), SUPER 3G, IMT-Advanced, 4G (4th generation mobile communication system), 5G (5th generation mobile communication system), 6th generation mobile communication system (6G), xth generation mobile communication system (xG) (xG (x is, for example, an integer, decimal)), FRA (Future Radio Access), NR (new Radio), New radio access (NX), Future generation radio access (FX), W-CDMA (registered trademark), GSM (registered trademark), CDMA2000, UMB (Ultra Mobile Broadband), IEEE 802.11 (Wi-Fi (registered trademark)), IEEE 802.16 (WiMAX (registered trademark)), IEEE 802.20, UWB (Ultra-WideBand), Bluetooth (registered trademark), and other appropriate systems, and a next generation system enhanced, modified, developed, or defined therefrom. Further, multiple systems may also be applied in combination (e.g., at least one of LTE and LTE-A combined with 5G, etc.).

The order of processing steps, sequences, flowcharts or the like of an aspect/embodiment described in the present specification may be changed as long as there is no contradiction. For example, in a method described in the present specification, elements of various steps are presented in an exemplary order. The order is not limited to the presented specific order.

The particular operations, that are supposed to be performed by the base station 10 in the present specification, may be performed by an upper node in some cases. In a network including one or more network nodes including the base station 10, it is apparent that various operations performed for communicating with the terminal 20 may be performed by the base station 10 and/or another network node other than the base station 10 (for example, but not limited to, MME or S-GW). According to the above, a case is described in which there is a single network node other than the base station 10. However, a combination of multiple other network nodes may be considered (e.g., MME and S-GW).

The information or signals described in this disclosure may be output from a higher layer (or lower layer) to a lower layer (or higher layer). The information or signals may be input or output through multiple network nodes.

The input or output information may be stored in a specific location (e.g., memory) or managed using management tables. The input or output information may be overwritten, updated, or added. The information that has been output may be deleted. The information that has been input may be transmitted to another apparatus.

A decision or a determination in an embodiment of the present invention may be realized by a value (0 or 1) represented by one bit, by a boolean value (true or false), or by comparison of numerical values (e.g., comparison with a predetermined value).

Software should be broadly interpreted to mean, whether referred to as software, firmware, middle-ware, microcode, hardware description language, or any other name, instructions, instruction sets, codes, code segments, program codes, programs, subprograms, software modules, applications, software applications, software packages, routines, subroutines, objects, executable files, executable threads, procedures, functions, and the like.

Further, software, instructions, information, and the like may be transmitted and received via a transmission medium. For example, in the case where software is transmitted from a website, server, or other remote source using at least one of wired line technologies (such as coaxial cable, fiber optic cable, twisted pair, digital subscriber line (DSL) and wireless technologies (infrared, microwave, etc.), at least one of these wired line technologies and wireless technologies is included within the definition of the transmission medium.

Information, a signal, or the like, described in the present specification may represented by using any one of various different technologies. For example, data, an instruction, a command, information, a signal, a bit, a symbol, a chip, or the like, described throughout the present application, may be represented by a voltage, an electric current, electromagnetic waves, magnetic fields, a magnetic particle, optical fields, a photon, or a combination thereof.

It should be noted that a term used in the present specification and/or a term required for understanding of the present specification may be replaced by a term having the same or similar meaning. For example, a channel and/or a symbol may be a signal (signaling). Further, a signal may be a message. Further, the component carrier (CC) may be referred to as a carrier frequency, cell, frequency carrier, or the like.

As used in the present disclosure, the terms “system” and “network” are used interchangeably.

Further, the information, parameters, and the like, described in the present disclosure may be expressed using absolute values, relative values from predetermined values, or they may be expressed using corresponding different information. For example, a radio resource may be what is indicated by an index.

The names used for the parameters described above are not used as limitations. Further, the mathematical equations using these parameters may differ from those explicitly disclosed in the present disclosure. Because the various channels (e.g., PUCCH, PDCCH) and information elements may be identified by any suitable names, the various names assigned to these various channels and information elements are not used as limitations.

In the present disclosure, the terms “BS: Base Station”, “Radio Base Station”, “Base Station”, “Fixed Station”, “NodeB”, “eNodeB (eNB)”, “gNodeB (gNB)”, “Access Point”, “Transmission Point”, “Reception Point”, “Transmission/Reception Point”, “Cell”, “Sector”, “Cell Group”, “Carrier”, “Component Carrier”, and the like, may be used interchangeably. The base station may be referred to as a macro-cell, a small cell, a femtocell, a picocell and the like.

The base station may accommodate (provide) one or more (e.g., three) cells. In the case where the base station accommodates a plurality of cells, the entire coverage area of the base station may be divided into a plurality of smaller areas, and each smaller area may provide communication services by means of a base station subsystem (e.g., an indoor small base station or a remote Radio Head (RRH)). The term “cell” or “sector” refers to a part or all of the coverage area of at least one of the base station and base station subsystem that provides communication services at the coverage.

In the present disclosure, terms such as “mobile station (MS)”, “user terminal”, “user equipment (UE)”, “terminal”, and the like, may be used interchangeably.

There is a case in which the mobile station may be referred to, by a person skilled in the art, as a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or some other appropriate terms.

At least one of the base station and the mobile station may be referred to as a transmission apparatus, reception apparatus, communication apparatus, or the like. The at least one of the base station and the mobile station may be a device mounted on the mobile station, the mobile station itself, or the like. The mobile station may be a vehicle (e.g., a car, an airplane, etc.), an unmanned mobile body (e.g., a drone, an automated vehicle, etc.), or a robot (manned or unmanned). At least one of the base station and the mobile station may include an apparatus that does not necessarily move during communication operations. For example, at least one of the base station and the mobile station may be an IoT (Internet of Things) device such as a sensor.

Further, the base station in the present disclosure may be read as the user terminal. For example, each aspect/embodiment of the present disclosure may be applied to a configuration in which communications between the base station and the user terminal are replaced by communications between multiple terminals 20 (e.g., may be referred to as D2D (Device-to-Device), V2X (Vehicle-to-Everything), etc.). In this case, the function of the base station 10 described above may be provided by the terminal 20. Further, the phrases “up” and “down” may also be replaced by the phrases corresponding to terminal-to-terminal communication (e.g., “side”). For example, an uplink channel, an downlink channel, or the like, may be read as a sidelink channel.

Further, the user terminal in the present disclosure may be read as the base station. In this case, the function of the user terminal described above may be provided by the base station.

The term “determining” used in the present specification may include various actions or operations. The “determining” may include, for example, a case in which “judging”, “calculating”, “computing”, “processing”, “deriving”, “investigating”, “looking up, search, inquiry” (e. g., looking up a table, database, or other data structures), or “ascertaining” is deemed as “determining”. Further, the “determining” may include a case in which “receiving” (e.g., receiving information), “transmitting” (e.g., transmitting information), “inputting”, “outputting”, or “accessing” (e.g., accessing data in a memory) is deemed as “determining”. Further, the “determining” may include a case in which “resolving”, “selecting”, “choosing”, “establishing”, “comparing”, or the like is deemed as “determining”. In other words, the “determining” may include a case in which a certain action or operation is deemed as “determining”. Further, “decision” may be read as “assuming”, “expecting”, or “considering”, etc.

The term “connected” or “coupled” or any variation thereof means any direct or indirect connection or connection between two or more elements and may include the presence of one or more intermediate elements between the two elements “connected” or “coupled” with each other. The coupling or connection between the elements may be physical, logical, or a combination thereof. For example, “connection” may be read as “access”. As used in the present disclosure, the two elements may be thought of as being “connected” or “coupled” to each other using at least one of the one or more wires, cables, and printed electrical connections and, as a number of non-limiting and non-inclusive examples, electromagnetic energy having wavelengths in the radio frequency region, the microwave region, and the light (both visible and invisible) region.

The reference signal may be abbreviated as RS or may be referred to as a pilot, depending on the applied standards.

The description “based on” used in the present specification does not mean “based on only” unless otherwise specifically noted. In other words, the phrase “base on” means both “based on only” and “based on at least”.

Any reference to an element using terms such as “first” or “second” as used in the present disclosure does not generally limit the amount or the order of those elements. These terms may be used in the present disclosure as a convenient way to distinguish between two or more elements. Therefore, references to the first and second elements do not imply that only two elements may be employed or that the first element must in some way precede the second element.

“Means” included in the configuration of each of the above apparatuses may be replaced by “parts”, “circuits”, “devices”, etc.

In the case where the terms “include”, “including” and variations thereof are used in the present disclosure, these terms are intended to be comprehensive in the same way as the term “comprising”. Further, the term “or” used in the present specification is not intended to be an “exclusive or”.

A radio frame may include one or more frames in the time domain. Each of the one or more frames in the time domain may be referred to as a subframe. The subframe may further include one or more slots in the time domain. The subframe may be a fixed length of time (e.g., 1 ms) independent from the numerology.

The numerology may be a communication parameter that is applied to at least one of the transmission and reception of a signal or channel. The numerology may indicate at least one of, for example, SubCarrier Spacing (SCS), bandwidth, symbol length, cyclic prefix length, transmission time interval (TTI), number of symbols per TTI, radio frame configuration, specific filtering processing performed by the transceiver in the frequency domain, and specific windowing processing performed by the transceiver in the time domain.

The slot may include one or more symbols in the time domain, such as OFDM (Orthogonal Frequency Division Multiplexing) symbols, SC-FDMA (Single Carrier Frequency Division Multiple Access) symbols, and the like. The slot may be a time unit based on the numerology.

The slot may include a plurality of mini slots. Each mini slot may include one or more symbols in the time domain. Further, the mini slot may be referred to as a sub-slot. The mini slot may include fewer symbols than the slot. PDSCH (or PUSCH) transmitted in time units greater than a mini slot may be referred to as PDSCH (or PUSCH) mapping type A. PDSCH (or PUSCH) transmitted using a mini slot may be referred to as PDSCH (or PUSCH) mapping type B.

A radio frame, a subframe, a slot, a mini slot and a symbol all represent time units for transmitting signals. Different terms may be used for referring to a radio frame, a subframe, a slot, a mini slot and a symbol, respectively.

For example, one subframe may be referred to as a transmission time interval (TTI), multiple consecutive subframes may be referred to as a TTI, and one slot or one mini slot may be referred to as a TTI. In other words, at least one of the subframe and the TTI may be a subframe (1 ms) in an existing LTE, a period shorter than 1 ms (e.g., 1-13 symbols), or a period longer than 1 ms. It should be noted that the unit representing the TTI may be referred to as a slot, a mini slot, or the like, rather than a subframe.

The TTI refers to, for example, the minimum time unit for scheduling in wireless communications. For example, in an LTE system, a base station schedules each terminal 20 to allocate radio resources (such as frequency bandwidth, transmission power, etc. that can be used in each terminal 20) in TTI units. The definition of TTI is not limited to the above.

The TTI may be a transmission time unit, such as a channel-encoded data packet (transport block), code block, codeword, or the like, or may be a processing unit, such as scheduling or link adaptation. It should be noted that, when a TTI is provided, the time interval (e.g., the number of symbols) during which the transport block, code block, codeword, or the like, is actually mapped may be shorter than the TTI.

It should be noted that, when one slot or one mini slot is referred to as a TTI, one or more TTIs (i.e., one or more slots or one or more mini slots) may be the minimum time unit for scheduling. Further, the number of slots (the number of mini slots) constituting the minimum time unit of the scheduling may be controlled.

A TTI having a time length of 1 ms may be referred to as a normal TTI (a TTI in LTE Rel. 8-12), a long TTI, a normal subframe, a long subframe, a slot, and the like. A TTI that is shorter than the normal TTI may be referred to as a shortened TTI, a short TTI, a partial TTI (or fractional TTI), a shortened subframe, a short subframe, a mini slot, a subslot, a slot, or the like.

It should be noted that the long TTI (e.g., normal TTI, subframe, etc.,) may be replaced with a TTI having a time length exceeding 1 ms, and the short TTI (e.g., shortened TTI, etc.,) may be replaced with a TTI having a TTI length less than the TTI length of the long TTI and a TTI length greater than 1 ms.

A resource block (RB) is a time domain and frequency domain resource allocation unit and may include one or more consecutive subcarriers in the frequency domain. The number of subcarriers included in a RB may be the same, regardless of the numerology, and may be 12, for example. The number of subcarriers included in a RB may be determined on the basis of numerology.

Further, the time domain of a RB may include one or more symbols, which may be 1 slot, 1 mini slot, 1 subframe, or 1 TTI in length. One TTI, one subframe, etc., may each include one or more resource blocks.

It should be noted that one or more RBs may be referred to as physical resource blocks (PRBs, Physical RBs), sub-carrier groups (SCGs), resource element groups (REGs), PRB pairs, RB pairs, and the like.

Further, a resource block may include one or more resource elements (RE). For example, 1 RE may be a radio resource area of one sub-carrier and one symbol.

The bandwidth part (BWP) (which may also be referred to as a partial bandwidth, etc.) may represent a subset of consecutive common RBs (common resource blocks) for a given numerology in a carrier. Here, a common RB may be identified by an index of RB relative to the common reference point of the carrier. A PRB may be defined in a BWP and may be numbered within the BWP.

BWP may include BWP for UL (UL BWP) and BWP for DL (DL BWP). For a terminal 20, one or more BWPs may be configured in one carrier.

At least one of the configured BWPs may be activated, and the terminal 20 may assume that the terminal 20 will not transmit and receive signals/channels outside the activated BWP. It should be noted that the terms “cell” and “carrier” in this disclosure may be replaced by “BWP”.

Structures of a radio frame, a subframe, a slot, a mini slot, and a symbol described above are exemplary only. For example, the number of subframes included in a radio frame, the number of slots per subframe or radio frame, the number of mini slots included in a slot, the number of symbols and RBs included in a slot or mini slot, the number of subcarriers included in a RB, the number of symbols in a TTI, the symbol length, the cyclic prefix (CP) length, and the like, may changed in various ways.

In the present disclosure, where an article is added by translation, for example “a”, “an”, and “the”, the disclosure may include that the noun following these articles is plural.

In this disclosure, the term “A and B are different” may mean “A and B are different from each other.” It should be noted that the term “A and B are different” may mean “A and B are different from C.” Terms such as “separated” or “combined” may be interpreted in the same way as the above-described “different”.

Each aspect/embodiment described in the present specification may be used independently, may be used in combination, or may be used by switching according to operations. Further, notification (transmission/reporting) of predetermined information (e.g., notification (transmission/reporting) of “X”) is not limited to an explicit notification (transmission/reporting), and may be performed by an implicit notification (transmission/reporting) (e.g., by not performing notification (transmission/reporting) of the predetermined information).

As described above, the present invention has been described in detail. It is apparent to a person skilled in the art that the present invention is not limited to one or more embodiments of the present invention described in the present specification. Modifications, alternatives, replacements, etc., of the present invention may be possible without departing from the subject matter and the scope of the present invention defined by the descriptions of claims. Therefore, the descriptions of the present specification are for illustrative purposes only, and are not intended to be limitations to the present invention.

The present application is based on and claims priority to Japanese patent application No. 2021-170070 filed on Oct. 18, 2021, the entire contents of which are hereby incorporated herein by reference.

### DESCRIPTION OF THE REFERENCE NUMERALS

10 Base station
110 Transmission unit
120 Reception unit
130 Configuration unit
140 Control unit
20 Terminal
210 Transmission unit
220 Reception unit
230 Configuration unit
240 Control unit
30 Core network
1001 Processor
1002 Storage device
1003 Auxiliary storage device
1004 Communication apparatus
1005 Input apparatus
1006 Output device
2001 Vehicle
2002 Drive unit
2003 Steering unit
2004 Accelerator pedal
2005 Brake pedal
2006 Shift lever
2007 Front wheel
2008 Rear wheel
2009 Axle
2010 Electronic control unit
2012 Information service unit
2013 Communication module
2021 Current sensor
2022 Revolution sensor
2023 Pneumatic sensor
2024 Vehicle speed sensor
2025 Acceleration sensor
2026 Brake pedal sensor
2027 Shift lever sensor
2028 Object detection sensor
2029 Accelerator pedal sensor
2030 Driving support system unit
2031 Microprocessor
2032 Memory (ROM, RAM)
2033 Communication port (IO port)

1. A terminal comprising:
a reception unit configured to receive downlink control information activating semi-persistent scheduling and downlink data according to the activated semi-persistent scheduling from a base station;
a control unit configured to determine a cell for feedback for the downlink data in a case where dynamic carrier switching is enabled; and
a transmission unit configured to use the determined cell to transmit feedback information corresponding to the downlink data to the base station.

2. The terminal as claimed in claim 1, wherein the control unit determines the cell for feedback for the downlink data, based on the downlink control information activating the semi-persistent scheduling.

3. The terminal as claimed in claim 2, wherein
the control unit multiplexes multiple pieces of feedback information included in different cells, and
the transmission unit uses the cell to transmit the multiplexed pieces of feedback information to the base station.

4. The terminal as claimed in claim 1, wherein the control unit determines the cell for feedback for the downlink data to be a default cell that is specified in advance.

5. A base station comprising:
a transmission unit configured to transmit downlink control information activating semi-persistent scheduling and downlink data according to the activated semi-persistent scheduling to a terminal;
a control unit configured to determine a cell for feedback corresponding to the downlink data in a case where dynamic carrier switching is enabled; and
a reception unit configured to use the determined cell to receive feedback information corresponding to the downlink data from the terminal.

6. A communication method of a terminal, the communication method comprising:
receiving downlink control information activating semi-persistent scheduling and downlink data according to the activated semi-persistent scheduling from a base station;
determining a cell for feedback for the downlink data in a case where dynamic carrier switching is enabled; and
using the determined cell to transmit feedback information corresponding to the downlink data to the base station.
